(19) United States
(12) Patent Application Publication
(10) Pub. No.: US 2026/0007910 A1
(43) Pub. Date: Jan. 8, 2026

(54) ENHANCED FACE MASKS FOR IMPROVED EFFICACY AND USABILITY

(71) Applicant: Amazon Technologies, Inc., Seattle, WA (US)

(72) Inventors: Adam C Siegel, Seattle, WA (US); Eliot Kim, Cupertino, CA (US)

(21) Appl. No.: 17/545,252

(22) Filed: Dec. 8, 2021

Related U.S. Application Data
(60) Provisional application No. 63/163,396, filed on Mar. 19, 2021.

(51) Int. Cl. A62B 23/02; A41D 13/11; A62B 18/08; B01D 39/08; B01D 39/16; B01D 46/00; B01D 46/52

(52) U.S. Cl. CPC A62B 23/025; A41D 13/11; A62B 18/084; A62B 18/088; B01D 39/083; B01D 39/16; B01D 46/0086; B01D 46/522; B01D 2239/0622; B01D 2239/0627; B01D 2239/065

(57) ABSTRACT

Face masks and related methods with improved filtering, wear-ability, quality of seal against a wearer's face, filtration efficiency, lifetime, and/or durability are provided. A face mask includes a filter assembly and a retention mechanism. The filter assembly is configured to conform to a face of a user and cover a nose and mouth of the user. The filter assembly can include a tessellated filter layer shaped to extend above and below a reference medial surface of the tessellated filter layer so that the tessellated filter layer has an air-filtering area greater than an area of the reference medial surface.

### CROSS REFERENCE TO RELATED APPLICATIONS

This application is a Nonprovisional of and claims priority to U.S. Provisional Application No. 63/163,396, filed Mar. 19, 2021, and titled “ENHANCED FACE MASKS FOR IMPROVED EFFICACY AND USABILITY,” and U.S. Provisional Application No. 63/160,410, filed Mar. 12, 2021, and titled “ENHANCED FACEMASKS FOR IMPROVED EFFICACY AND USABILITY,” the contents of each are herein incorporated in their entirety.

### BACKGROUND

An N95 mask meets the U.S. National Institute for Occupational Safety and Health (NIOSH) N95 classification of air filtration, which requires the mask to filter out at least 95% of airborne particles. N95 masks do not typically filter out gases or vapors.

N95 masks may be effective in reducing transmission of the severe acute respiratory syndrome coronavirus 2 (SARS-CoV-2). High demand and limited supply of N95 masks, during the pandemic of 2020-2021 resulted in price gouging, hoarding, and a proliferation of ineffective or uncomfortable alternatives to N95 masks.

### BRIEF DESCRIPTION OF THE DRAWINGS

Various embodiments in accordance with the present disclosure will be described with reference to the drawings, in which:

FIGS. 1 and 2 illustrate an example face-conforming face mask that includes a three-dimensional tessellated filter layer, according to some embodiments;

FIGS. 3 through 5 illustrate example three-dimensional tessellation patterns that can be employed in a face mask, according to some embodiments;

FIGS. 6 and 7 illustrate an example face-conforming face mask that includes an enclosed three-dimensional tessellated filter layer, according to some embodiments;

FIG. 8 illustrates example face-conforming face masks that have an external appearance similar to an item of apparel, according to some embodiments;

FIG. 9 illustrates an example usage limit indicator that can be employed in a face mask, according to some embodiments;

FIGS. 10 through 12 illustrate example retention strap configurations that can be employed in a face mask, according to some embodiments;

FIG. 13 illustrates an example face mask with a dome configuration, according to some embodiments;

FIG. 14 is a simplified block diagram of a process of fabricating a set of face masks for reducing inhalation of respiratory droplets to reduce exposure to viruses and other microscale pathogens, according to some embodiments;

FIG. 15 is a simplified block diagram of a process of selecting a face mask for use by a specific person for reducing inhalation of respiratory droplets to reduce exposure to viruses and other microscale pathogens, according to some embodiments;

FIG. 16 illustrates different example face shapes and sizes that can be used in the process of FIG. 14;

FIG. 17 illustrates an approach of enabling selection of a best-fitting face mask for use by a specific person, according to some embodiments;

FIG. 18 illustrates an example use of a mobile application to measure facial dimensions that can be used in the process of FIG. 15.

FIGS. 19 through 21 illustrate a clustering approach that can be used in the process of FIG. 14;

FIG. 22 illustrates an example face-conforming face mask, according to some embodiments;

FIG. 23 illustrates an example internal conformal structure for an improved face mask, according to some embodiments;

FIG. 24 illustrates an example internal support structure for an improved face mask, according to some embodiments;

FIG. 25 illustrates an example face mask including a self-cleaning material, according to some embodiments;

FIG. 26 illustrates an example face mask including a partially transparent structure, according to some embodiments;

FIG. 27 illustrates an example face mask including a patterned transparent structure, according to some embodiments;

FIG. 28 illustrates an example face mask incorporating an electrostatic ionizer, according to some embodiments;

FIG. 29 illustrates an example face mask including an air conditioning structure, according to some embodiments;

FIG. 30 illustrates an example user interface pairing to a mask, according to some embodiments;

FIG. 31 illustrates an example self-adherent face mask 1000, according to some embodiments;

FIG. 32 illustrates an example face mask including an air bypass structure, according to some embodiments;

FIG. 33 illustrates an example technique for fabricating a face mask including tessellated folds, according to some embodiments;

FIG. 34 illustrates an example technique for fabricating electronic circuits on a face mask, according to some embodiments;

FIG. 35 and FIG. 36 shows an example tri-fold mask worn by a mannequin, according to some embodiments;

FIG. 37 illustrates some example trim lines for a tri-fold masks, according to some embodiments;

FIG. 38 shows an example tri-fold mask that includes a conformal memory foam upper member, according to some embodiments;

FIG. 39 shows an example tri-fold mask that includes darts, according to some embodiments;

FIG. 40 shows an example custom printed internal frame for a mask, according to some embodiments;

FIG. 41 shows another example custom printed internal frame for a mask, according to some embodiments;

FIG. 42 shows an example custom printed internal frame for a mask interfaced with a mannequin, according to some embodiments;

FIG. 43 shows views of a mannequin wearing an example bi-fold mask with an internal frame, according to some embodiments; and

FIG. 44 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

N95 masks have proven to be effective in protecting the wearer from inhaling air pollutants such as PM2.5 particulate matter, and in reducing exposure to and transmission of airborne communicable diseases such as influenza and severe acute respiratory syndrome coronavirus 2 (SARS-CoV-2). Factors attributable to mask structure and material influence the adoption of masks by diverse users including, but not limited to, adults, children, specialized professionals, or essential workers. Among the factors, wearer comfort, filtration effectiveness, or mask lifetime are often cited among the reasons limiting adoption and regular wearing of masks. Improvements to the materials, functionality, and structure of N95 masks, therefore, may promote broad adoption of masks in essential workplaces, schools, and in society at large, thereby assisting public health efforts to protect the general public from air pollution and communicable diseases and to reduce the reproduction of communicable diseases, for example, as measured by the effective reproduction number (“R” factor).

Fit testing is a critical component to a respiratory protection program whenever workers use tight-fitting respirators, such as N95 masks. Numerous factors influence the quality of fit. For example, facial hair at the sealing area of the respirator will cause it to leak. As N95 masks are not approved for routine decontamination and reuse, comfort of wear, quality of fit, and perceptions of use are all important factors to improve duration of use and broad adoption of N95 mask use.

Techniques described herein include materials, structures, and methods of fabrication of face masks. In particular, the techniques include materials, structures, and methods for improving the wear-ability, quality of seal against a wearer's face, filtration efficiency, lifetime, and/or durability of masks that are configured to meet N95 filtration standards. In some embodiments, the mask may incorporate additional structures to improve conformity with a wearer's face, for example, through cloth webbing, conformable lining or frames, or dynamic shape-adjusting materials. In other embodiments, the mask may incorporate support structures facilitating a replaceable or removable filtration element. In still other embodiments, the materials from which a mask is fabricated may incorporate biocidal or otherwise cytotoxic inclusions. In yet still further embodiments, the material from which a mask is fabricated may incorporate one or more transparent regions and one or more permeable regions, such that parts of a wearer's face may be visible while wearing the mask. In some embodiments, a mask may incorporate electronic components including, but not limited to sensors, electrostatic charging components, convective cooling, or thermo-electric components. In some embodiments, electronic components of the mask may include communications elements, such that a mobile electronic device may pair with the mask and receive information from sensor(s) incorporated in the mask. In some embodiments, the mask may include tensile or shaped structures internal to the mask, such that the mask adheres to a wearer's face without straps or other retention elements. In some embodiments, a mask may include an adjustable vent. The adjustable vent may include a manually adjustable mechanical iris and/or an automatically (e.g., without human interaction) adjusting mechanical iris. The automatically adjusting iris may be controlled by electronic components receiving data from sensor(s) incorporated in the mask. In some embodiments, the material from which the mask is formed may be folded according to one or more tessellated patterns, thereby increasing the surface area of the mask and improving wearer comfort. In some embodiments, the mask may include printed circuits that maintain conductive contact to electronic components after being formed into a mask.

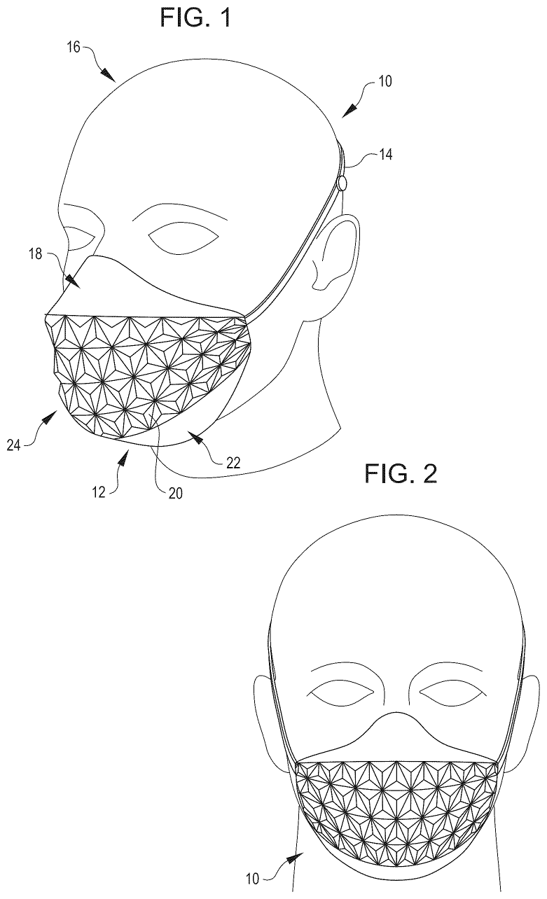

Turning now to the drawing figures in which similar reference identifiers refer to similar elements, FIGS. 1 and 2 illustrate an example face-conforming face mask 10 for reducing inhalation of respiratory droplets to reduce exposure to viruses and other microscale pathogens. The face mask 10 includes a filter assembly 12 and one or more retention straps 14. The filter assembly 12 is configured to conform to a face of a user 16 and cover a nose and mouth of the user. In the illustrated embodiment, the filter assembly 12 has a tri-fold configuration including an upper panel 18, a middle panel 20, and a lower panel 22. The middle panel 20 comprising a tessellated filter layer 24 having three-dimensional tessellations shaped to extend above and below a reference medial surface of the tessellated filter layer 24 so that the tessellated filter layer 24 has an air-filtering area of at least 1.2 times of an area of the reference medial surface. In some embodiments, the tessellated filter layer 24 has an air-filtering area of at least 1.5 times of an area of the reference medial surface. The one or more retention straps 14 are configured to retain the filter assembly 12 to the face of the user 16.

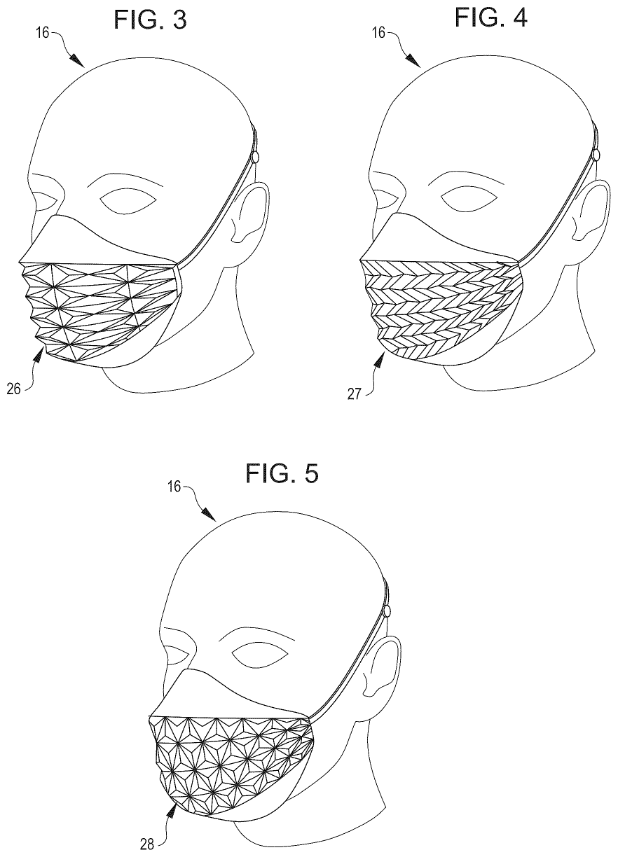

The tessellated filter layer 24 can have any suitable three-dimensional tessellations so that the tessellated filter layer 24 extends above and below a reference medial surface of the tessellated filter layer 24. In many embodiments, the tessellated filter layer 24 has an air-filtering area of at least 1.2 times of an area of the reference medial surface. For example, FIGS. 3 through 5 illustrate example tessellation patterns 26, 27, 28 that can be employed in the filter assembly 12. Tessellation pattern 26 has diamond origami pattern shaped three-dimensional tessellations. Tessellation pattern 27 has Miura-Origami pattern shaped three-dimensional tessellations. Tessellation pattern 28 has triangle twist origami pattern shaped three-dimensional tessellations.

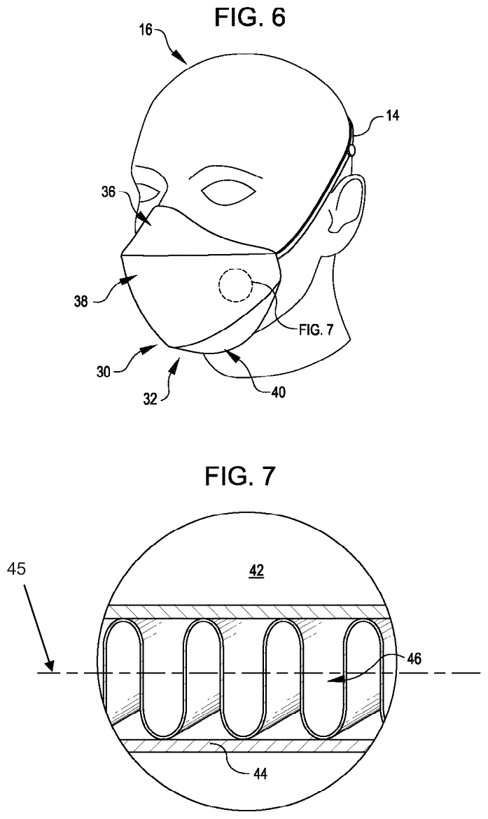

FIGS. 6 and 7 illustrates an example face-conforming face mask 30 for reducing inhalation of respiratory droplets to reduce exposure to viruses and other microscale pathogens. The face mask 30 includes a filter assembly 32 and one or more retention straps 14. The filter assembly 32 is configured to conform to a face of a user 16 and cover a nose and mouth of the user 16. In the illustrated embodiment, the filter assembly 32 has a tri-fold configuration including an upper panel 36, a middle panel 38, and a lower panel 40. The filter assembly 32 includes an outer layer 42, and inner layer 44, and an enclosed tessellated filter layer 46. The enclosed tessellated filter layer 46 has a corrugated configuration in which the filter layer 46 is shaped to extend above and below a reference medial surface 45 of the enclosed tessellated filter layer 46 so that the enclosed tessellated filter layer 46 has an air-filtering area of at least 1.2 times of an area of the reference medial surface 45. In some embodiments, the enclosed tessellated filter layer 46 has an air-filtering area of at least 1.5 times of an area of the reference medial surface 45. The outer layer 42 can have any suitable configuration. In some embodiments, the outer layer 42 has a smooth top surface. The inner layer 44 can have any suitable configuration. In some embodiments, the inner layer 44 has a smooth bottom surface. The one or more retention straps 34 are configured to retain the filter assembly 32 to the face of the user 16.

The outer layer 42, the inner layer 44, and the enclosed tessellated filter layer 46 can form any suitable portions of the filter assembly 32. For example, in the illustrated embodiment, the outer layer 42 forms a portion of each of the upper panel 36, the middle panel 38, and the lower panel 40. In some embodiments, the enclosed tessellated filter layer 46 forms part of the middle panel 38 and does not form a part of either of the upper panel 36 and the lower panel 40. The enclosed tessellated filter layer 46, however, can have any suitable configuration including, but not limited to, extending beyond the middle panel 38 to form any suitable portion of the upper panel 36 and/or the lower panel 40.

The filter assembly 32 can be made from any suitable materials. For example, the outer layer 42 can be made essentially of a suitable spunbond polypropylene. The enclosed tessellated filter layer 46 can be made essentially of a suitable meltblown polypropylene. The inner layer 44 can be made essentially of a suitable spunbond polypropylene.

The filter assemblies 12, 32 can include nanofibers, such as those that can be obtain by electrospinning, to increase the breathability of the filter assemblies 12, 32 while maintaining high filtration efficiency characteristic of N95 masks. A filter assembly made with nanofibers has a greater porosity (volume of void compared to total volume), for an identical pore size, in comparison with a filter assembly made from fibers thicker than nanofibers. Greater porosity translates into a reduction of the resistance to air flow through the filter assembly. Electrospinning is a nanofiber production method that uses electric force to draw charged threads of polymer solutions or polymer melts up to fiber diameters on the order of some hundred nanometers. Electrospinning employs a high voltage electric field with positively and negatively charged ends. The polymer is loaded at one end of the electric field and stretched to the oppositely charged end, creating a long, thin strand. A resulting network of nanofibers can be spun directly onto a base layer for backing and support. Electrospinning does not require the use of coagulation chemistry or high temperatures to produce solid threads from solution. Electrospinning may be particularly suited to the production of fibers using large and complex molecules.

Meltblown nonwoven fibers, commonly used as filtration media in surgical and N95 masks, have a diameter of around 10 microns. During the manufacture of meltblown nonwoven fibers, a polymer melt is extruded through small nozzles surrounded by high-speed blowing gas, creating fibers less than a micron wide deposited onto a conveyor belt. Meltblown fabrics can be given an electrostatic charge to improve filtration efficiency. Electrospinning can be used to produce fibers with a diameter of less than 0.15 microns. Nanofiber networks have high porosity and a large surface area-to-volume ratio, which makes nanofiber networks extremely useful in filtration applications. The filtration mechanisms of meltblown fabrics and nanofiber networks are slightly different. While both materials will mainly filter large particles through sieving, small particles will be filtered through electrostatic attraction in case of meltblown fabrics, and interception/inertial impaction in case of nanofiber fabrics. Electrospun nanofibers are characterized by a very large surface area, which significantly increases the probability of the particles depositing on the fiber surface. Meltblown fabrics exhibit generally better filtration performances than nanofibers when first worn. Rapid depletion of electrostatic charge of a meltblown fabric, however, especially in presence of moisture, can result in a rapid reduction in filtration efficiency. Because filtration efficiency of a nanofiber network is not dependent on electrostatic charging, the nanofilter network may retain its filtration efficiency over time better than a meltblown fabric.

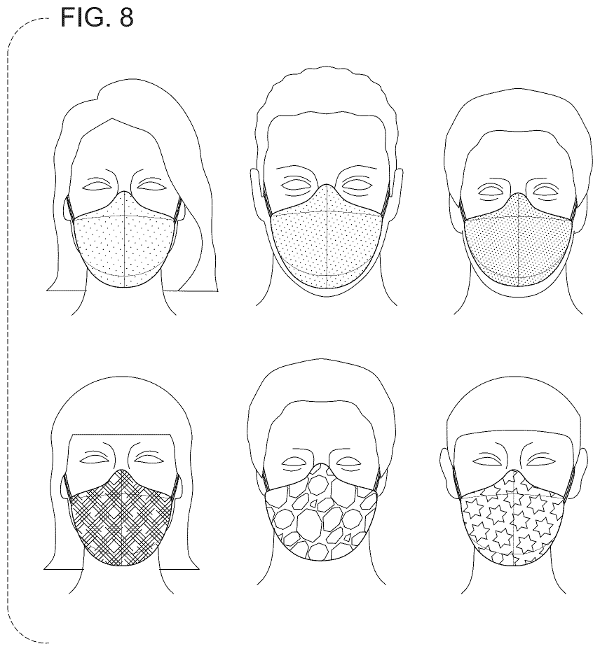

The face-conforming face masks described herein, such as the face masks 10, 30, can be configured to have a desired external appearance. For example, FIG. 8 illustrates example embodiments of the face masks 10, 30 that have an external appearance similar to an item of apparel. A desired external appearance can be achieved via any suitable approach. For example, inkjet printing can be used to print a desired image on the exterior of the filter assembly 32. In another example, the filter assembly 32 can include an additional outer layer (e.g., a fabric layer) to provide a desired external appearance to the face mask.

Spunbond polypropylene fabrics can be printed by Roll-to-Roll printing (also known as Direct-to-Fabric printing). Flexographic printing is a common roll-to-roll printing technique for spunbond polypropylene. Flexography is a form of printing process that utilizes a flexible relief plate to transfer ink onto a substrate. Flexography is economical and fast for large quantities. However, modifications to the patterns require the manufacturing of a specially designed flexible relief plate and adjustments to the numerous parameters of the printing equipment. Thus, this technique cannot be used for individually designed patterns. Inkjet can be used to customize the appearance of the face-conforming face masks, such as those described herein.

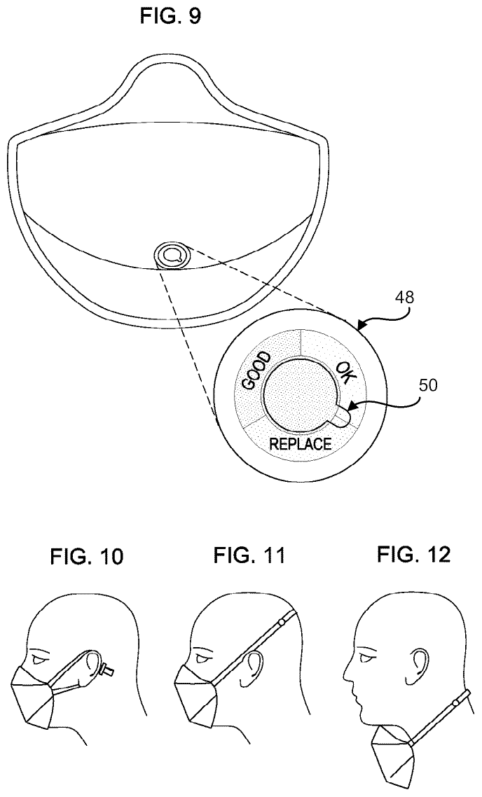

The face-conforming face masks described herein, such as the face masks 10, 30, can include an indicator configured to display an indication of whether the face mask has exceeded a usage limit for the face mask. For example, FIG. 9 illustrates an example usage limit indicator 48 that can be employed in any of the face masks described herein. In the illustrated embodiment, the usage limit indicator 48 includes a peel tab 50 that is removed to expose an underlying usage indicating layer that changes color during usage of the face mask from an initial color to another color that indicates that the face mask has reached the end of its usable life and should be replaced.

The usage limit indicator 48 can be attached to the face mask in any suitable location including, but not limited to, to an inner surface of the face mask in the illustrated embodiment. The usage limit indicator 48 can be used to inform the wearer of when the replacement of the mask is needed. Time indicator labels are used in food packaging and healthcare industries. Time indicators can be divided into two categories, based on how these are used: “click-to-activate” and “peel-to-activate”. In the “click-to-activate” category, a small capsule is broken to release the viscous colored liquid it contains. The liquid migrates through a channel, thus visually indicating the elapsed time. The second category, “peel-to-activate”, corresponds to indicators where a small layer covering and protecting the indicator, is removed for activation. The removal of the protective layer exposes the indicator to the air, which either oxidates its chemical compound or slowly releasing a compound, thus initiating the color change. Many indicators are dependent on the external temperature, at it affects the viscosity of the liquid, therefore the time needed to migrate.

The one or more retention straps 14 can have any suitable configuration. For example, the one or more retention straps 14 (as shown in FIGS. 10 through 12) can be configured to be at least one of adjustable in length, wrapped around ears of the user, or extend around a neck of the user to retain the face mask when not worn on the face of the user.

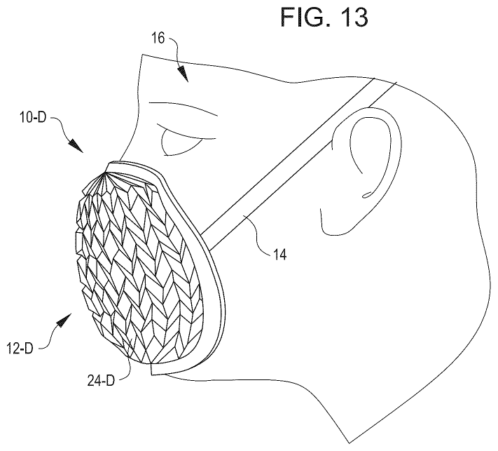

FIG. 13 illustrates an example face-conforming face mask 10-D that includes a filter assembly 12-D and one or more retention straps 14. The filter assembly 12-D is configured similar to the filter assembly 12, but has a domed configuration. The filter assembly 12-D has a tessellated filter layer 24-D that is configured similar to the tessellated filter layer 24 of the filter assembly 12. Similar to the tessellated filter layer 24, the tessellated filter layer 24-D has three-dimensional tessellations shaped to extend above and below a reference medial surface of the tessellated filter layer 24-D so that the tessellated filter layer 24-D has an air-filtering area of at least 1.2 times of an area of the reference medial surface. In some embodiments, the tessellated filter layer 24-D has an air-filtering area of at least 1.5 times of an area of the reference medial surface. The one or more retention straps 14 are configured to retain the filter assembly 12-D to the face of the user 16.

In many embodiments, the filter assemblies described herein employ filter layers that have been folded into origami tessellation patterns to increase the comfort of the filter assembly by reducing resistance to air flow through the filter assembly. The folded filter layer provides higher filtering efficiency relative to non-folded filter layers of the same area coverage.

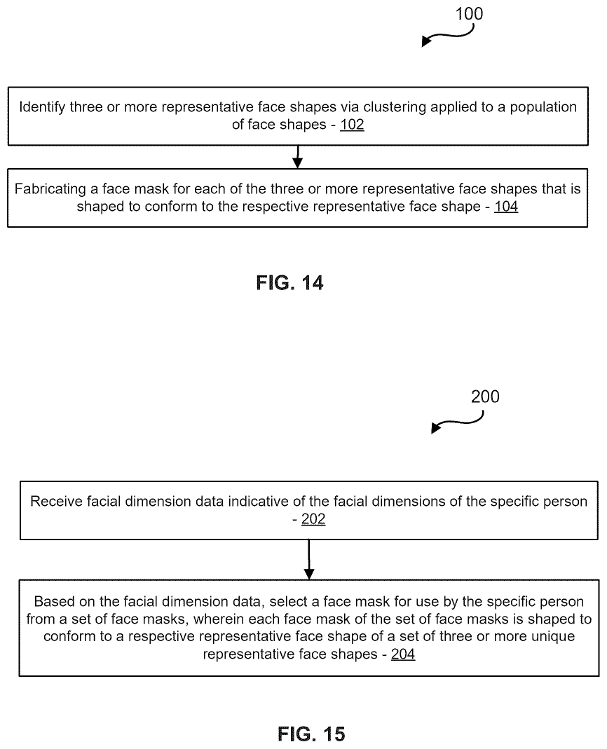

FIG. 14 is a simplified block diagram of a process 100 of fabricating a set of face-conforming face masks for reducing inhalation of respiratory droplets to reduce exposure to viruses and other microscale pathogens, according to some embodiments. The process 100 can be used to fabricate a set of any suitable face-conforming face masks, such any of the face-conforming face masks described herein.

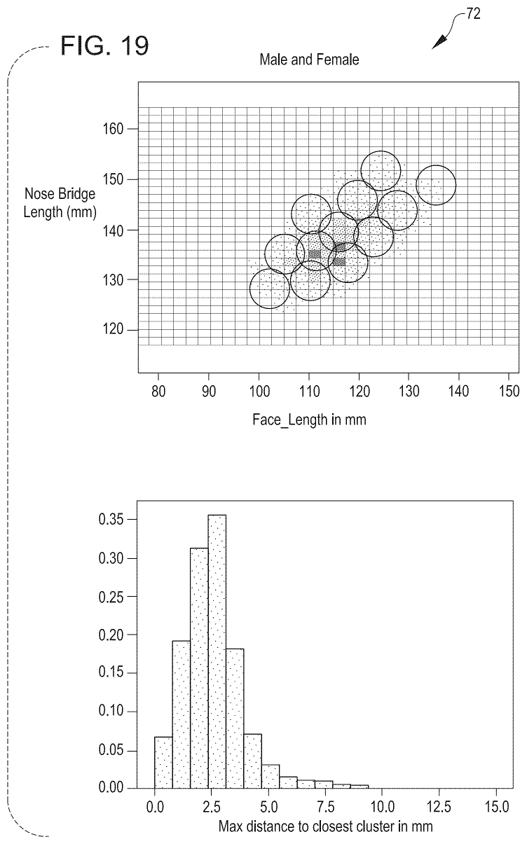

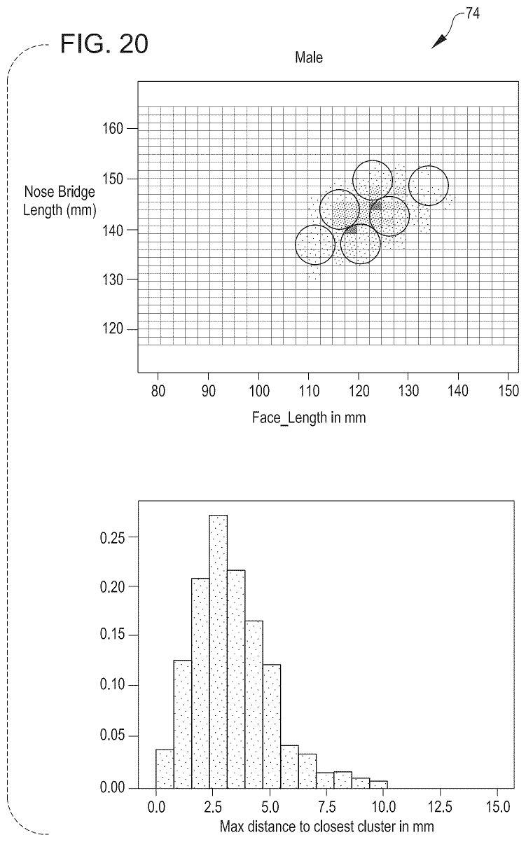

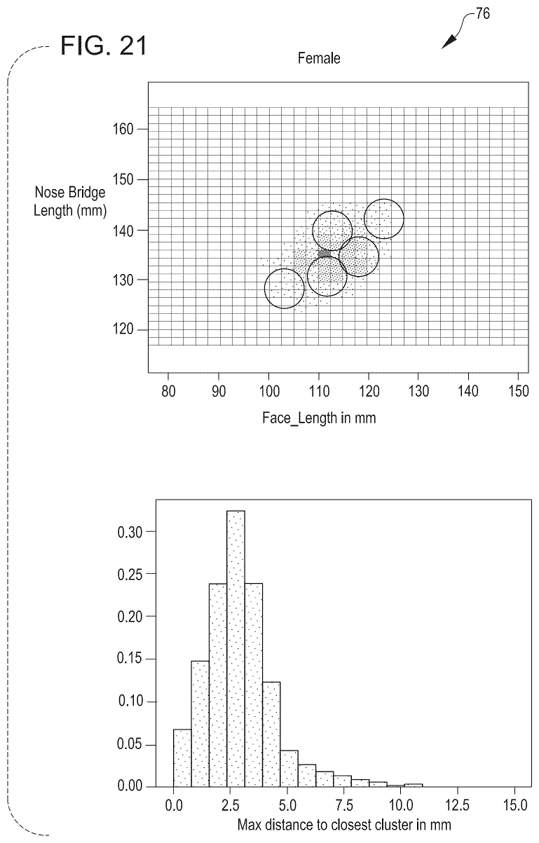

In some embodiments, the process 100 includes generating a multi-dimensional representation indicative of distribution of facial dimensions for a population of persons. Any suitable multi-dimensional representation indicative of distribution of facial dimensions for a population of persons can be generated for any suitable population of persons. Any suitable facial dimensions can be used to generate the multi-dimensional representation indicative of distribution of facial dimensions for a population of persons. In some embodiments, the facial dimensions used to generate the multi-dimensional representation include two of face length, face width, and nose bridge length. FIGS. 19 through 21 shows examples of suitable multi-dimensional representations 72, 74, 76 indicative of distribution of facial dimensions for a population of persons. The multi-dimensional representation 72 is a heat map employing face length and nose bridge length for a population including males and females. The multi-dimensional representation 74 is a heat map employing face length and nose bridge length for a population including only the males from the population used in the multi-dimensional representation 72. The multi-dimensional representation 76 is a heat map employing face length and nose bridge length for a population including only the females from the population used in the multi-dimensional representation 72. FIG. 16 illustrates different example face shapes and sizes that can be used in the process 100.

In act 102, three or more representative face shapes are identified via clustering applied to a population of face shapes. For example, as illustrated in FIGS. 19 through 21, clusters of face shapes having facial dimensions within suitably small dimensional ranges are identified graphically via adding circles of a suitable radius to the multi-dimensional representation. A single representative face shape for each of the identified clusters can be selected corresponding to the facial dimensions indicated by the center of each of the circles. While 12 representative faces are identified in the example illustrated in FIGS. 19 through 21, any suitable number of clusters can be employed so that a sufficient number of representative faces are selected to ensure the resulting set of face masks produced based on the selected representative faces includes a suitably dimensioned face mask for any person of most if not all of the population of persons employed. For example, FIGS. 19 through 21 show bar charts indicating the distribution of maximum length magnitudes of either face length or nose bridge length from the corresponding best matching representative face facial dimensions for each of the populations employed in the multi-dimensional representations 72, 74, 76. As shown, about 90% of the faces within the population of faces have a face length and nose bridge length within 5 mm of an identified best matching representative face.

In act 104, a face mask is fabricated for each of the three or more representative face shapes (identified in act 102) that is shaped to conform to the respective representative face shape. Any suitable approach can be employed to fabricate the face masks. For example, a three-dimensional model (e.g., a virtual computer model, an actual physical model) for each of the representative face shapes can be generated or constructed and used in the design and/or fabrication of the respective face-conforming face mask.

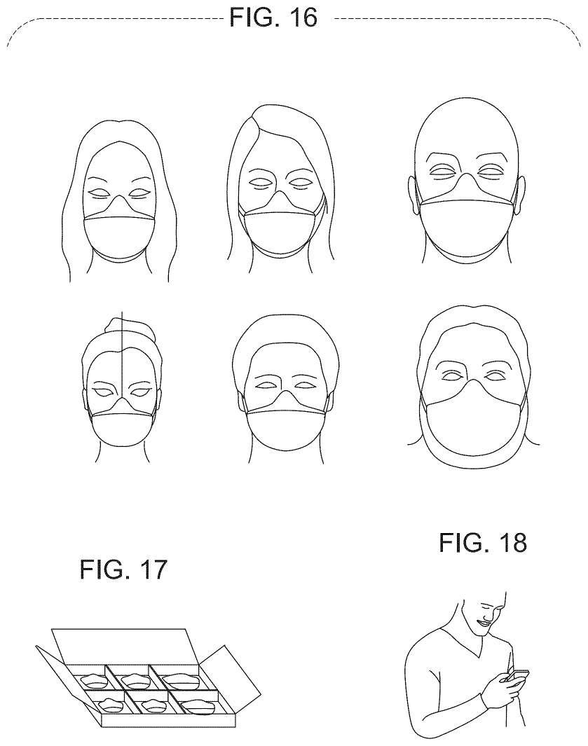

FIG. 15 is a simplified block diagram of a process 200 of selecting a face mask for use by a specific person for reducing inhalation of respiratory droplets to reduce exposure to viruses and other microscale pathogens, according to some embodiments. The process 200 can be used to select a face-conforming face mask for a specific person from any suitable set of face-conforming face masks, such any of the face-conforming face masks described herein. In some embodiments of the process 200, an application executable on a user device is used to measure facial dimensions via an imaging device. The application can be configured for use with any suitable user device that includes an imaging device, such as a smart phone. In act 202, facial dimension data indicative of the facial dimensions of the specific person are received. In act 204, based on the facial dimension data, a face mask for use by the specific person is selected from a set of face masks. Each face mask of the set of face masks is shaped to conform to a respective representative face shape of a set of three or more unique representative face shapes. The set of representative face shapes can include any suitable number (e.g., 3, 4, 5, 6, or more) of representative face shapes. In an alternative approach, an entire set of face masks designed for the set of representative face shapes is provided to the specific person and one mask is selected from the set of face masks that fits the best and the rest are returned to the mask provider (as illustrated in FIG. 17). The person can keep track of the size of the mask selected for use in ordering additional masks.

### Custom-Moldable Mask Liner

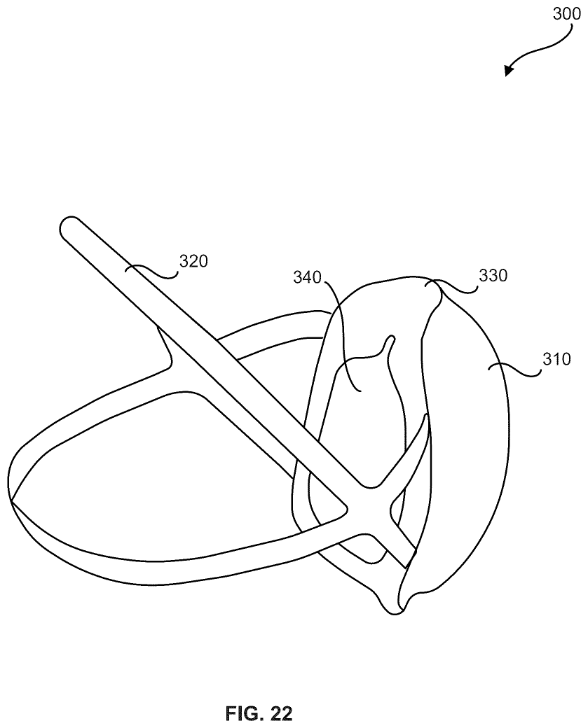

FIG. 22 illustrates an example face mask 300 including a conformal structure, according to some embodiments. In contrast to a typical mask, the face mask 300 may include structures and materials that can be molded to a wearer. Such materials may be incorporated into a seal around the contact periphery of the face mask 300.

In the embodiment shown in FIG. 22, the face mask 300 includes a filter layer 310. The filter layer 310 may serve to capture viral particles and/or droplets containing virus that are expelled by a wearer during exhalation up to, including, or exceeding the N95 standard. The filter layer 310 may further serve to protect the wearer during inhalation, for example, by capturing the viral particles and droplets containing virus suspended in an area around the wearer. To that end, the filter layer 310 may be configured to at least partially fit against a face of the wearer and to surround the mouth and nose of the wearer. An opening 340 is provided for receiving the mouth, nose, and generally the chin area of a face of a wearer.

To improve and/or perfect the seal of the filter layer 310 to the face of the wearer, the face mask 300 may further include a tensioning element 320 and/or a lining 330. The lining is positioned around the periphery of the opening 340. In some embodiments, the tensioning element 320 may be or include any structure configured to hold the filter layer 300 onto the face of the wearer, such that the face mask 300 covers the mouth and nose of the wearer. For example, the tensioning element 320 may include, but is not limited to, ear loops or one or more elastic or otherwise adjustable head bands that pull the face mask 300 into contact with face of the wearer.

The lining 330 may include a cloth material, similar to the material from which the filter layer 310 is formed, which may be incorporated into the face mask 300 in such a way that the lining 330 forms a continuous seal around the periphery of opening 340 in the face mask 300. For example, the lining 330 may be affixed to a proximal surface of the filter layer 310 (e.g., at a position that defines the outer edges of the opening 340), relative to the face of the wearer. In one embodiment, the lining 330 is in sheet form with a central opening and attached at outer edges to the periphery of the opening of the mask. The filter layer 310 is made of sufficient structural integrity to support the lining 330 in tension from the periphery, in such a way that it is under tension and is forced by that tension to extend from the proximal surface toward the wearer. In this way, the lining 330 aligns against the face of a wearer and pressing inward by the face of the wearer increases contact with the lining and enhances the seal on the wearer's face. Thus, the lining 330 forms a peripheral contact with the face of the wearer that adjusts to movement of the face of the wearer, such as movement of the mouth or jaw of the wearer.

In some embodiments, the lining 330 incorporates memory foam or shape-change materials. The lining 330 may be or include any material that exhibits viscoelastic shape change properties permitting the lining 330 to reversibly conform to the face of the wearer. In this context, reversibly conforming refers to a material capability to conform to a wearers face when the wearer is wearing the mask and to retain a conformation for a period of time, after which the material may return to a neutral form (e.g., as when the lining 330 incorporates “memory” materials). For example, the lining may include, but is not limited to, ethylene-vinyl acetate foam or polyurethane-based memory-foam. In some embodiments, the lining 330 includes a plastic or a foam that is flexible when it is heated above a threshold temperature. In this way, the lining may be molded to the face of the wearer subsequent to being warmed. As an exemplary material, the lining 330 may be or include polycaprolactone. Polycaprolactone is a lightweight polyester thermoplastic with a glass transition temperature of about 150° F. (60° C.). In this way, by heating the lining 330 above the glass transition temperature of polycaprolactone, the lining 330, and thus the face mask, may be reversibly molded to the face of the wearer, for example, by molding the face mask 300 to the face of the wearer while it is above 60° C. and subsequently cooling the face mask 300 below 60 C. In some embodiments, rubber latex can also be used for the conformable liner to provide a room temperature conformal seal against the face of the wearer. Similarly, the lining 330 may include or incorporate liquid phase-change materials. For example, the liquid phase-change materials may include, but are not limited to, eutectic-phase metal alloys, polymeric materials, or other materials exhibiting a phase transition temperature at or near a typical surface temperature of human skin. In some embodiments, the liquid phase-change materials are incorporated into bubbles of the foam materials, such that the bubbles melt and expand when warmed by body heat.

Advantageously, incorporating the lining 330 may improve the effectiveness of the face mask 300, at least in part by improving the quality of the seal and channeling air through the filter layer 310, rather than around the peripheral edge of the filter layer 310. Similarly, the lining may improve the comfort experienced by the wearer while donning the mask, for example, by reducing the force applied by the tensioning member 320 to achieve an equivalent seal on the face of the wearer. Furthermore, the lining 330 may improve the lifetime of the mask, for example, by potentially reducing the frequency of repositioning, donning, doffing, and otherwise adjusting the face mask 300, due at least in part to the face mask 300 conforming more comfortably to the face of the wearer.

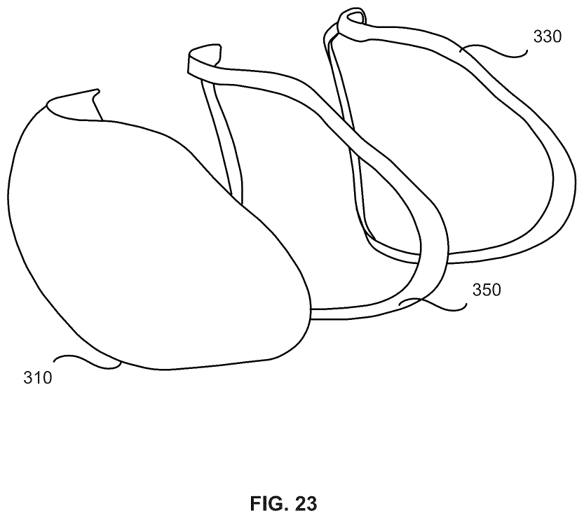

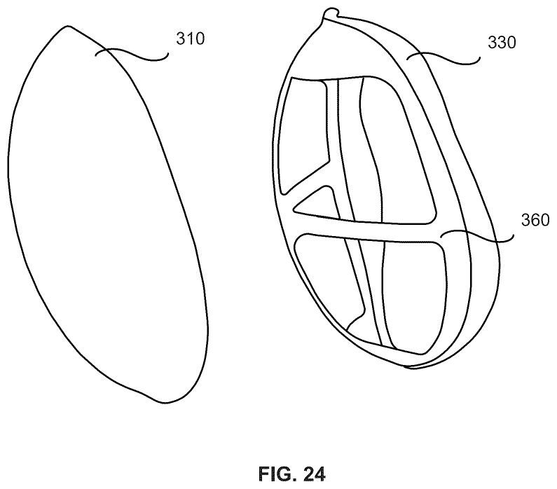

FIG. 23 illustrates an example internal conformal structure for an improved face mask, according to some embodiments. In addition to the lining described in reference to FIG. 22 (e.g., lining 330 of FIG. 22), a face mask may incorporate one or more internal structures and/or materials to facilitate the conformal contact of the lining to the face of the wearer. In some embodiments, the face mask may include a frame 350 interposed between a filter layer 310 and a lining 330. In some embodiments, the frame 350 may be or include a viscoelastic material, selected to impermanently adhere to both the filter layer 310 and the lining 330, as opposed to being cemented or permanently fixed, for example, to facilitate replacement of the frame 350 and/or the lining 330. As an illustrative example, the frame 350 may be or include a conformable gasket shaped to conform to a peripheral region of the proximal surface of the filter layer 310. In this way, the lining 330, which may be or include a cloth selected for comfort of the wearer or for the capability of forming a seal when at least partially compressed. As such, the material of the lining 330 may include, but is not limited to, a cotton cloth, a synthetic woven polymer cloth, a melt-blown unwoven polymer cloth, or other materials receptive to sterilization without thermal or chemical degradation.

FIG. 24 illustrates an example internal support structure for an improved face mask, according to some embodiments. In addition to a viscoelastic support (e.g., frame 350 of FIG. 23), a face mask (e.g., face mask 300 of FIG. 22) may include additional or alternative structures and/or materials that may improve the useful lifetime of the face mask, the durability of the mask, or the efficacy of the mask to conform to a face of a wearer. In some embodiments, a face mask includes a filter layer 310, which may be formed and/or molded to conform to a support 360. In contrast to the frame 350 described in reference to FIG. 23, the support 360 may be or include a rigid or a flexible plastic frame, molded to fit over a mouth and a nose of a wearer of the face mask. The support 360 may improve efficacy of a face mask at least in part by reducing the likelihood that the filter layer 310 folds or otherwise pinches during donning, doffing, or wearing, such that air does not circumvent the filter layer 310. Similarly, the lining 330, which may include natural or synthetic cloths as described in reference to FIG. 22 and FIG. 23, may provide an improved seal against the face of the wearer, for example, when the support 360 is molded to the face of the wearer or is otherwise contoured. Furthermore, the filter layer 310, the support 360, and the lining 330 may be removably attached, facilitating the replacement of any one of the elements of the face mask. In this way, the useful life of the face mask may be prolonged, for example, by replacing the lining 330 after every use and replacing the filter layer 310 after every fifth use, as may be recommended by health guidelines for reuse of personal protective equipment. The support 360, if cleaned or otherwise sanitized, may potentially be reused for a longer period.

### Virucidal Mask Materials

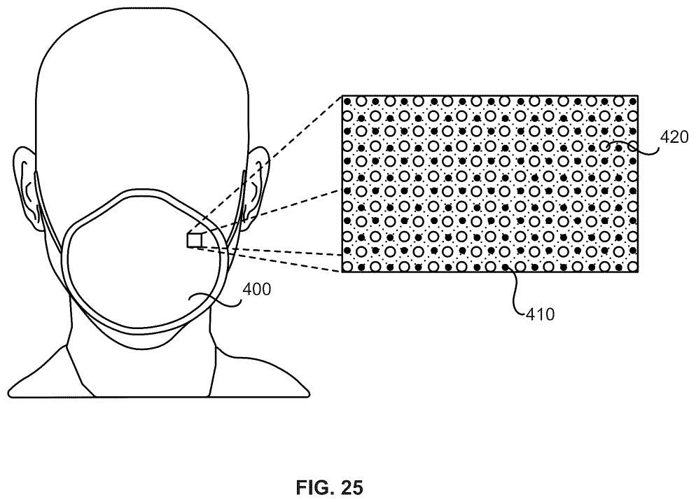

FIG. 25 illustrates an example face mask including a self-cleaning material 400, according to some embodiments. In one approach to preserving the cleanliness of a face mask (e.g., face mask 300 of FIG. 22), material from which the mask is made may include biocidal inclusions or coatings. The coatings may include metal oxide particles 410, such as copper, zinc, or silver oxide particles deposited on a surface of the self-cleaning material 400. The metal oxide particles 410 may be deposited on a proximal surface of the self-cleaning material 400, relative to the face of the wearer, may be deposited on the distal surface of the self-cleaning material 400, may be deposited on both surfaces, or the self-cleaning material 400 may be impregnated with the metal oxide particles 410. Additionally or alternatively, the self-cleaning material 410 may include biocidal polymers 420 deposited in a similar manner, where the biocidal polymers 420 include a chemical selected to denature virus that contacts the biocidal polymers 420. In some embodiments, the biocidal polymers 420 include polyethyleneimines (PEI) or poly(allylamine hydrochloride) (PAH) plastics. In some embodiments, self-cleaning material 400 that includes the biocidal polymers 420 and/or the metal oxide particles 410 may exhibit as much as a 4 log reduction in virus titer (i.e., >99.99% reduction) within a characteristic time frame of several minutes of contact on different types of viruses. In this way, a face mask incorporating the self-cleaning material 400 as a filter layer may self-sanitize after as few as 10 minutes or less. This may provide an improvement to the lifetime of the mask, as in circumstances where the mask is infrequently used. Furthermore, the self-cleaning material may protect those who touch a mask to pick up a contagion, such that touching surfaces, such as plates or other common surfaces, and touching the face may be less likely to cause infection.

### Transparent or Semi-Transparent Masks

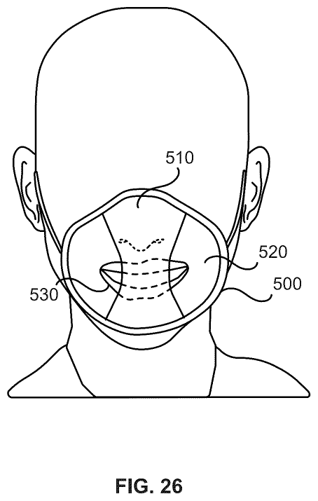

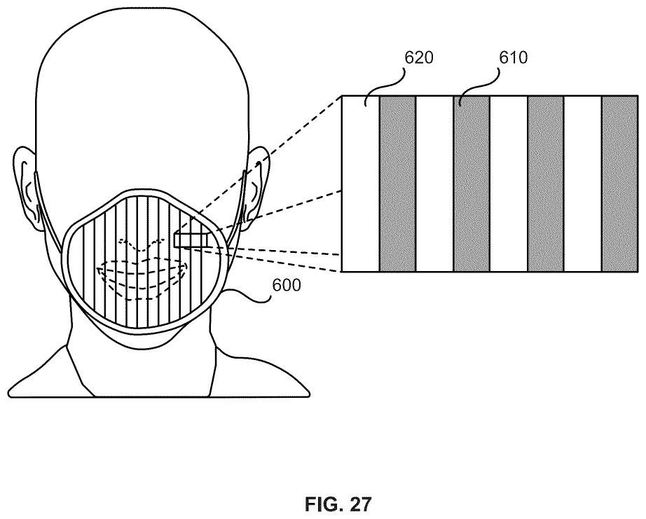

FIG. 26 and FIG. 27 illustrate example face masks 500, 600 including a partially translucent or transparent structure, according to some embodiments. In a public place or other environment where people may need to communicate while wearing masks, communication may be hampered by masks obscuring facial features and other common non-verbal cues. For example, for those who are hearing-impaired, conversations may be facilitated by lip-reading. As such, a mask, obscuring a view of a wearers mouth, may inhibit the ability of participants in a conversation to effectively communicate. In another example, facial cues, such as smiles or frowns, may be enrich conversations by imparting meaning to words, such as sarcasm, or by indicating a mood without speaking.

As illustrated in FIG. 26, the face mask 500 may include a filtering portion 510, being opaque, and a translucent or transparent portion 520, through which at least a portion of the wearer's mouth 530 may be seen. The filtering portion 510 may be or include a similar material to that described in reference to FIG. 22 (e.g., filter layer 310 of FIG. 22). The translucent or transparent portion 520, by contrast, may be or include an impermeable plastic, such as polyethylene terephthalate or other transparent moldable and flexible plastic, such that the a mask may provide filtration through the filtering portion 510. As illustrated, the filtering portion may be centered in the mask over a region including a nose and a mouth of the wearer while the wearer is wearing the mask, so that exhalation directly impinges on the filtering portion 510, which may provide advantages including, but not limited to, improved trapping of particles and droplets exhaled by the wearer, reduced pressure drop across the mask, and reduced fogging and/or moisture condensation on the transparent portion 520 that would otherwise block visibility of the wearer's mouth 530.

FIG. 27 illustrates an example face mask 600 including a patterned translucent or transparent structure, according to some embodiments. As with the face mask 500 of FIG. 26, the face mask 600 may include a filtering portion 610 and a transparent portion 620, such that the wearer's mouth may be seen through the transparent portion 620 while the mask is worn. As illustrated, the face mask 600 may include multiple transparent portions 620 and multiple filtering portions 610, arranged as vertical stripes, which may provide improved facial recognition and facial cue reading.

In some embodiments, the face mask 500 and/or the face mask 600 may include a composite material including transparent fibers and non-transparent fibers. For example, the transparent portion 620 and the filtering portion 610 may be different materials joined by lamination and/or localized melting to join without blending. As an illustrative technique, the transparent portion 620 may be joined to the filtering portion 610 by laser-induced melting to weld the two portions, by contact melting using a heated template or die, or by other means to join the two portions without negatively impacting the transparency or permeability, respectively. In some embodiments, the material from which the face mask 500 and/or the face mask 600 is fabricated may be selected such that it becomes translucent or transparent after melting or fusing fibers that permit it to act as the filtering portion. In this way, a uniform layer of the material may be patterned by localized heating or other reaction to form the translucent or transparent portion. For example, in the context of the face mask 600, a laser controller may be programmed to drive a laser to form the repeating vertical stripes of the face mask 600 by controllably melting the filtering portion 610 to produce the transparent portion 620.

In some embodiments, a facial recognition algorithm, implemented using machine learning, may be trained to recognize faces through the face mask 500 and/or the face mask 600. Obscuring the nose and mouth of a wearer may interfere with facial recognition technology based at least in part on mapping facial features including the position and size of the nose and mouth. In this way, the translucent or transparent portions 520 and/or 620 may permit a facial recognition algorithm to be trained to recognize a face despite the nose and/or the mouth of the wearer being at least partially obscured.

### Electrostatic Charging

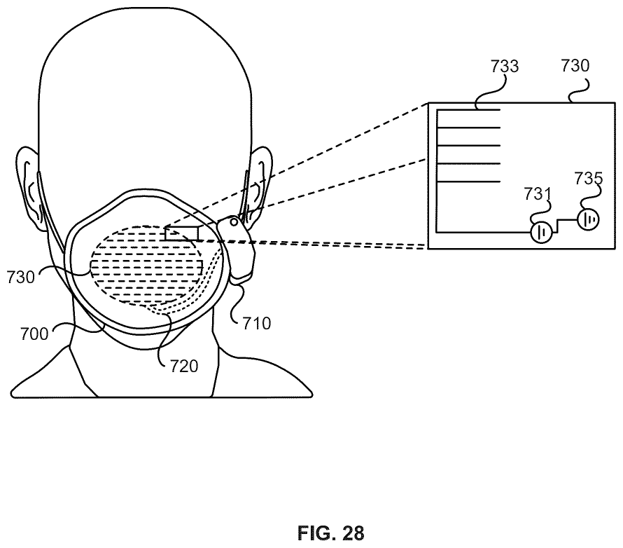

FIG. 28 illustrates an example face mask 700 incorporating an electrostatic charging element, according to some embodiments. Electrostatic charging and precipitation provides effective and rapid removal of viral particles and moisture droplets containing virus from the air. Electrostatic charging and/or precipitation may be facilitated by structures incorporated into the face mask 700 to impart a net charge on droplets and particles, and/or to attract and remove charged particles from the air.

As illustrated in FIG. 28, the face mask 700 includes a battery-powered system including a controller 710, electrically connected through leads 720 incorporated into or onto the mask material to an electrostatic charging element 730. While the face mask 700 is shown with a battery system, the face mask 700 may also include an electrostatic charging element 730 that operates passively by being periodically recharged, for example, by being connected to a charging unit external to the face mask 700.

Multiple approaches may be applied to implement electrostatic charging and removal of viral particles and/or droplets. For example, the electrostatic charging element 730 may include a high-voltage power supply 731 incorporated into the controller 710 that is connected to one or more electrodes 733 incorporated into the electrostatic charging element 730 and may be connected to a reference ground 735. The electrostatic charging element 730 may be positively biased, such that when energized by an electrostatic potential on the order of 10 VDC, 100 VDC, 1000 VDC, 10000 VDC, etc., a corona discharge may form in proximity to the one or more electrodes 733. In another example, the face mask 700 may be charged by loading the material of the face mask (e.g., the filter layer 310 of FIG. 22) or a reservoir of the electrostatic charging element 730 with an ionic liquid or a liquid that produces a charged vapor when evaporated. In this example, applying an electric field through the electrostatic charging element 730 may induce inductive charging by evaporating the liquid. In another example, the electrostatic charging element 730 may incorporate triboelectric charging layers, whereby friction between the charging layers separates charges and generates an electrostatic potential between the charging layers. As an exemplary implementation, the triboelectric charging layers may be or include ceramic material(s) arranged of a multi-layer piezoelectric stack, whereby a high-frequency signal generated by the controller 710 may induce triboelectric charge separation.

In some embodiments, hydrostatic “supercharging” may improve viral capture with reduced filtering material. For example, an electrostatically-charged filter may be formed by saturating nonwoven material (e.g., melt-blown polymer fabric) with an ionic liquid or an otherwise charged liquid, and subsequently removing the liquid via suction to create a charge separation that leaves the filter material bearing a static electrical charge. Advantageously, such an approach may improve filtration efficiency as much as 20× relative to uncharged material, and may provide a 50% reduction in the pressure drop vs. a standard N95 mask, in that masks made from a hydrostatic supercharged material may incorporate a thinner filter material.

Similarly, thin, electrospun filter fibers may provide a reduced pressure differential across the filter material, relative to melt-blown fibers. Furthermore, an electrospun polymer nonwoven fabric can be charged during formation to improve electrostatic attraction of virus droplets and/or particles. As a characteristic parameter of manufacturing, a void fraction of the fabric can be controlled by spin process parameters (e.g., accelerating voltage, flow control parameters, etc.). Advantageously, replacing melt-blown nonwoven fabric with electrospun nonwoven fabric may provide a reduced pressure drop across the filter material, which may in turn improve the comfort of the wearer and improve adoption of masks by wearers who may be sensitive to pressure drop.

In some embodiments, the electrostatic charging of the mask material is implemented by a charging station external to the mask. In this way, a mask may be “recharged” by being placed on or in an active region of the charging station. The charging station may include the active components described in reference to the face mask 700. For example, the charging station may have a high-voltage source that draws power from a standard home source (e.g., 120 VAC or 230 VAC), and may incorporate electronic components to generate a high-voltage electric field near a charging platform that can be used to charge or recharge a mask. In this way, face masks may be charged, for example, by exposure to a corona discharge near the charging platform, without incorporating electronic components into the mask itself.

### Embedded Thin-Film Microfan

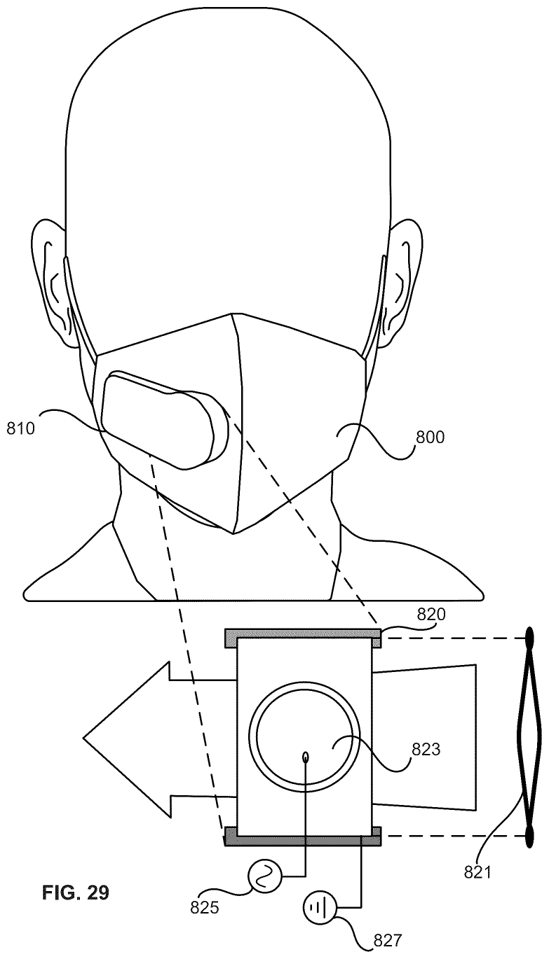

FIG. 29 illustrates an example face mask 800 including an air conditioning structure, according to some embodiments. Among the various factors cited as a reason for mask fatigue, discomfort caused by humidity, heat, and “stuffiness” is a major issue. To that end, the face mask 800 incorporates one or more elements to circulate, cool, and dry the air in the face mask 800. For example, the face mask may include a heat exchange unit 810 including a convective conduit and a fan 811. The fan 811 may draw air into the heat exchange unit 810 and pass it through the convective conduit to remove heat from a cooling circuit internal to the heat exchange unit 810. For example, the cooling circuit may be or include a thermoelectric cooling circuit (e.g., a Peltier cooler) having a “hot” terminal and a “cold” terminal, where the hot terminal may be outside the face mask 800 and the cold terminal may be inside the face mask 800. In this way, the hot terminal may be cooled by exposure to the air flow in the convective conduit, while the cold terminal may be warmed by convectively cooling the air inside the face mask 800.

To that end, on a proximal surface of the face mask 800, relative to a face of the wearer, the face mask 800 may include a convective element 820 in thermal communication with the thermoelectric circuit of the heat exchange unit. The convective element 820 may include, but is not limited to, a piezo-electric bellows configured to circulate the air between the face mask 800 and the face of the wearer. In some embodiments, the convective element may include one or more leaves 821, on which a piezoelectric actuator 823 may be disposed. Through applying an periodic voltage 825 to the piezoelectric actuator 823, the convective element 820 may drive the air circulation through reversible contraction of one or more of the leaves. To reduce the potential for electric shock of the wearer, the convective element may be electrically connected to a ground reference 827. Through heat exchange with the thermoelectric circuit, for example, by thermal communication with the cold terminal, the one or more leaves 821 may be maintained at a relatively low temperature, which may also serve to condense moisture from the air that may be wicked or absorbed into the filter layer of the face mask 800.

In some embodiments, the face mask 800 does not include the fan external to the mask or the thermoelectric cooling system. In this way, the convective element 820 may cool the face of the wearer of the face mask 800 by convective cooling without actively cooling the air between the face mask 800 and the face of the wearer.

### Embedded Sensors and Mobile Device Pairing

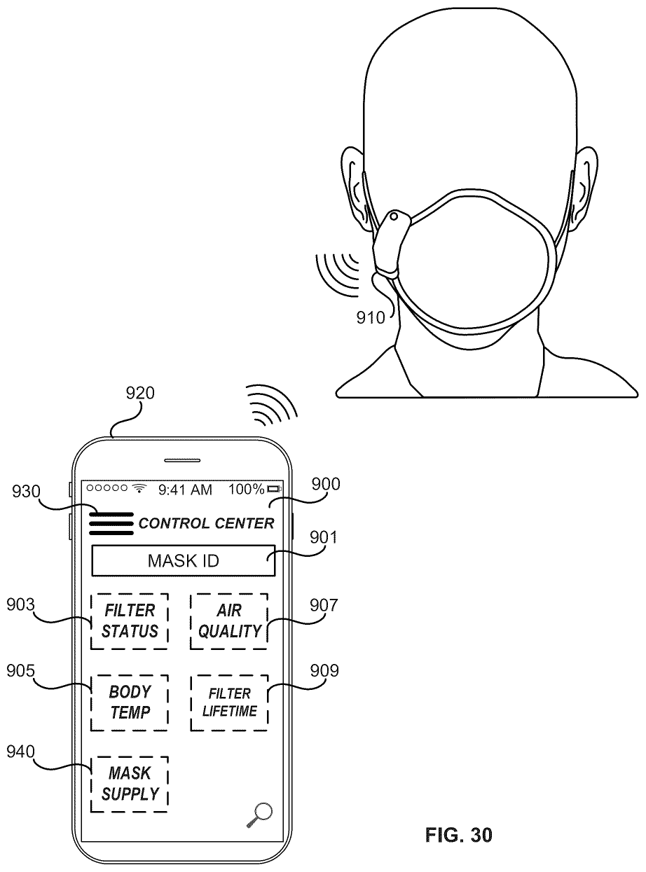

FIG. 30 illustrates an example user interface 900 pairing to a mask 910, according to some embodiments. Face masks may include electronic components selected to improve the lifetime, reuse, and efficacy of protection to the wearer. For example, by incorporating sensors, a wearer may be provided, through the user interface 900, useful information about the mask 910 and the environment. Furthermore, the user interface 900 may also provide useful information to the wearer about availability of replacement masks. In the context of the preceding examples, the user interface 900 may also inform the user when electronic components, such as electrostatic charging elements, heat exchange units, etc., may need to be recharged, for example, through sensors for measuring the electrostatic charge of the mask

In some embodiments, the mask 910 includes integrated sensors paired to a mobile device 920 (e.g., by Bluetooth or WiFi standards), running an application 930 that is configured to present sensor output and derived values based on the sensor output through the user interface 900. The integrated sensors may include, but are not limited to physiological sensors, such as body temperature, respiratory rate, respiratory force, speech patterns, etc. For example, a microphone, a thermometer (e.g., an IR sensor, thermocouple, etc.), and a pressure sensor, integrated into the mask 910, may be paired with the mobile device 920, such that the application 930 predicts whether the wearer is healthy or is presenting symptoms of a respiratory illness (e.g., COVID-19). Additionally or alternatively, external sensors may be included to measure air quality (e.g., PM2.5) or humidity, and adjust one or more control parameters of integrated systems accordingly, as described in more detail in reference to FIG. 32, below.

The user interface 900 may present various types of information to the wearer. For example, the information may include, but is not limited to, filter status 903, body temperature 905, air quality 907, or filter lifetime 909 information. The information thus presented may be derived from sensor output received by the mobile device 920 from the sensors incorporated into the mask 910. In some embodiments, the application 930 may also receive supply and logistical information from a marketplace or other network, such that the user interface 900 may also present mask supply information 900 to the wearer, permitting the wearer to request a replacement mask in response to receiving an indication through the user interface 900 that the mask 910 is nearing the end of its filter lifetime 909.

### Adherent Mask

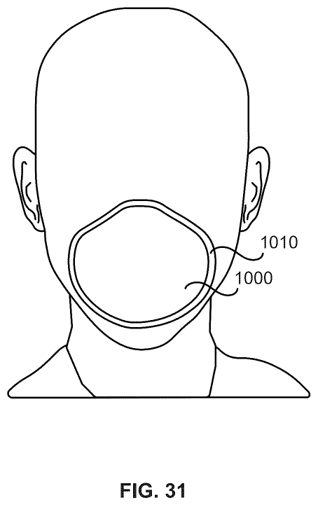

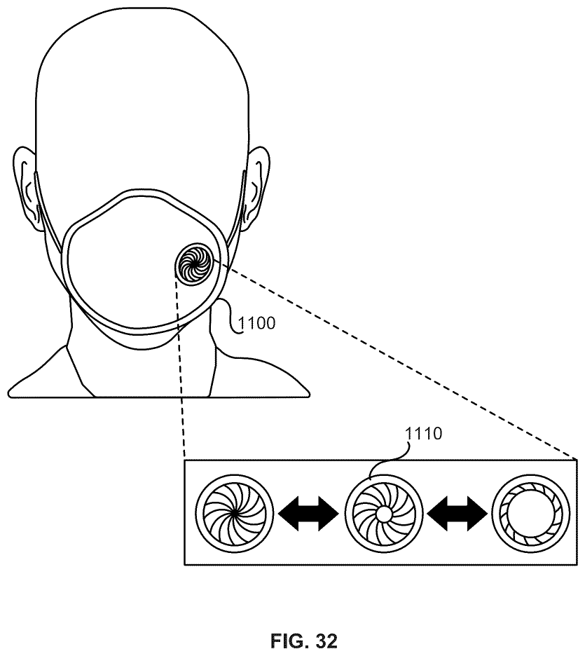

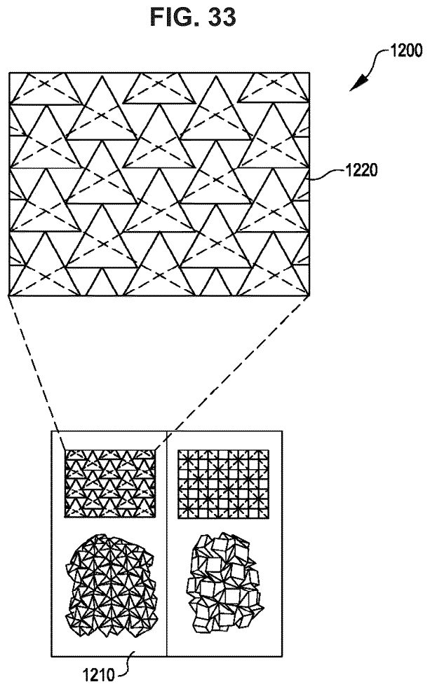

FIG. 31 illustrates an example self-adherent face mask 1000, according to some embodiments. For some wearers, the application of tension around the head or the ears proves uncomfortable and leads to repeated adjustment, donning, or doffing of masks, which limits the efficacy of masks to protect the wearer. As such, a mask that adheres to the face without straps or loops may improve the comfort of the mask and increase the time that the mask is worn. As illustrated in FIG. 31, the self-adherent face mask 1000 includes a peripheral frame 1010 defining a perimeter of the mask, encompassing a nose and mouth of the wearer, surrounding the filter material (e.g., filter layer 310 of FIG. 22). In some embodiments, the peripheral frame 1010 includes both rigid and elastic materials, such that the weight of the mask is supported from the nose, in a manner similar to eyeglasses, while a tacky lining material provides a reversible seal against the lower sections of the face of the wearer. In some embodiments, the peripheral frame 1010 includes a liner made of fibers that contract with the application of a voltage from a voltage source incorporated into the self-adherent face mask 1000. In some embodiments, the peripheral frame 1010 includes a tensioned element within the peripheral frame 1010 that is configured to grip one or more places of the wearers face, such as the bridge of the nose or around chin of the wearer.

### Adjustable Vent for Control of Air Flow Through Filter

FIG. 32 illustrates an example face mask 1100 including an air bypass structure, according to some embodiments. As described previously in reference to FIG. 29, “stuffiness” or stale air is often cited as a reason for removing masks, which may limit the efficacy of the mask to protect the wearer. In this way, incorporating an adjustable vent 1110 (e.g., an iris, cap, or shutter) in the side of the face mask 1100 may permit the user to repeatedly exchange air across the face mask 1100 without doffing the face mask 1100. In some embodiments, the adjustable vent 1100 may be activated manually by the wearer, electronically by the wearer, or autonomously (e.g., without wearer interaction) by an electronic control circuit.

In some embodiments, the adjustable vent 1110 may include an iris, as illustrated in FIG. 32. That being said, other examples include, but are not limited to, contractile fibers where the filtering efficacy may be provided when contracted. Such fibers may include fibers that change shape under an induced voltage or above a threshold humidity. In some embodiments, an air quality sensor may be integrated into the face mask 1100, such that the wearer may be alerted when the air quality outside the face mask 1100 is unhealthy, which may protect the wearer from additional environmental contaminants, such as smoke or hazardous chemicals.

In some embodiments, the face mask 1100 may include multiple adjustable vents 1110, such that the wearer may eating, drinking, or otherwise access the mouth and/or nose while wearing the face mask 1100.

### Tessellated Fold

FIG. 33 illustrates an example technique 1200 for fabricating a face mask including tessellated folds, according to some embodiments. An detectable pressure drop across a face mask serves as a significant factor affecting wearer mask fatigue and limiting the widespread adoption of face masks. In particular, wearers with limited respiratory capacity may find breathing through a mask to be tiring after a period of time. To that end, increasing a filtration area of a face mask will reduce the pressure drop across the mask, and may increase mask adoption.

In some embodiments, a filtering material (e.g., filter layer 310 of FIG. 22) may be formed into a three-dimensional structure 1210 according to a tessellated pattern 1220 that produces a topographical surface with an increased filtration area. The three dimensional structure may be formed by folding the filtering material, by molding the filtering material on a last, or by other means of inducing a plastic transition in the shape of the filtering material. In some embodiments, the filtering material used may be or include a composite material, such that folds correspond to different materials and/or properties to channel inhalation/exhalation to specific regions or the face mask. For example, this may include, but is not limited to, transparent materials, materials with varying surface area density or permeability to moisture.

Advantageously, the tessellated design may provide improved flexibility and/or contiguity with the facial contours of the wearer. For example, the tessellated pattern 1220 may include fractal elements, such that toward a peripheral region the feature size decreases, which may improve the capability of the three-dimensional structure 1210 to conform to the facial contours.

### Printed Circuits

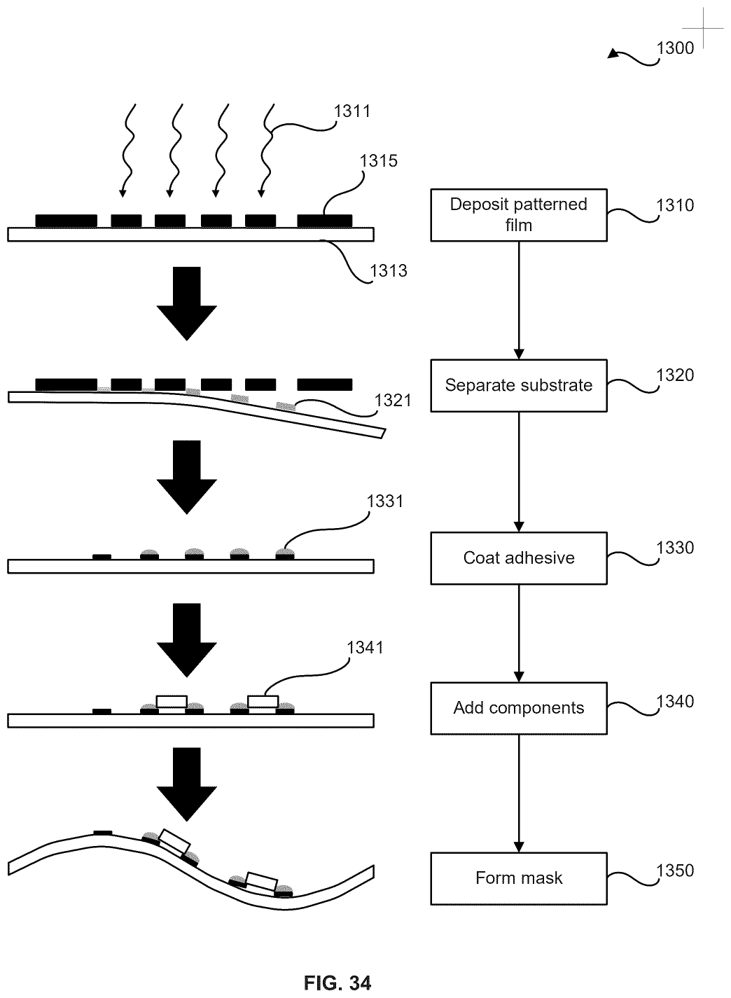

FIG. 34 illustrates an example technique 1300 for fabricating electronic circuits on a face mask, according to some embodiments. The various examples described above in reference to FIGS. 22 through 33 may include electronic circuits and electronic components. For example, the three-dimensional structure described in reference to FIG. 33 may include a circuit integrated onto the surface of the filter material. Circuitry may include insulated wires which may need to be glued or otherwise fixed to the filter material, which increases the resources needed to manufacture the mask, both in terms of material and labor. To that end, face masks may include printed circuits, deposited by one or more techniques for disposing a conductive film on the filtration material.

In some embodiments, fabricating electronic circuits on a filter material of a face mask may include, at operation 1310, depositing a metal vapor 1311 onto a substrate 1313 that may be or include the filter material, where the deposition may be patterned by being deposited through a mask 1315. The mask may be or include a stencil applied to the filter material 1313. Following deposition, the substrate 1313 may be separated from the mask 1315 at operation 1320, leaving a conductive film 1321 on the substrate 1313 with a pattern transferred through the mask 1315.

Subsequent removal of the mask 1315, the conductive film 1321 may be at least partially coated with adhesive 1331 at operation 1330. The adhesive may be applied by techniques including, but not limited to, printing, selective adhesion by surface tension, or by manual application. The adhesive may be or include an electrically conductive material. Prior to setting the adhesive 1331, one or more electronic components 1340 may be disposed on the substrate 1313, for example, by being affixed to one or more points on the conductive film 1321. The electrical components 1340 may include, but are not limited to, light sources, sensors, actuation components, or other electronic circuit elements, permitting the mask to carry electronics, implement sensor systems, and send and receive wireless transmissions (e.g., by patterning a planar antenna onto the substrate 1313). As a result, the substrate 1313 may include, on at least one surface, the conductive film 1321 and one or more electronic components 1341 in electrical communication with the conductive film 1321. The substrate 1313, so configured, may be formed into a filter layer (e.g., filter layer 310 of FIG. 22) for a face mask at operation 1350.

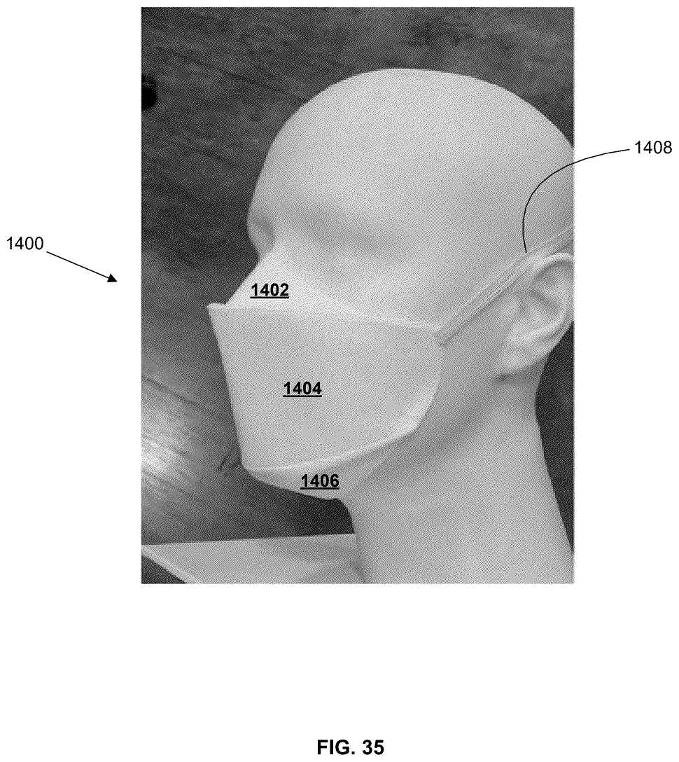

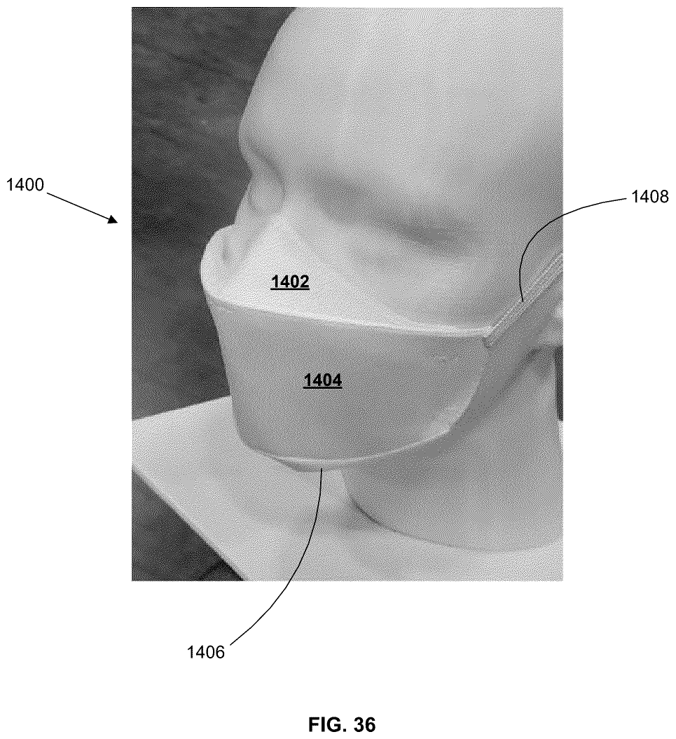

FIG. 35 and FIG. 36 shows an example tri-fold mask 1400 worn by a mannequin, according to some embodiments. The tri-fold mask 1400 includes an upper panel 1402, a middle panel 1404, a lower panel 1406, and a single strap 1408. The upper panel 1402 and the middle panel 1404 are joined via an internal seam that joins an inwardly folded perimeter edge portion of the upper panel 1402 to a corresponding inwardly folded perimeter edge portion of the middle panel 1404. The middle panel 1404 and the lower panel 1406 are joined via an internal seam that joins an inwardly folded perimeter edge portion of the middle panel 1404 to a corresponding inwardly folded perimeter edge portion of the lower panel 1406. The internal seams provide for smoother and more aesthetic appearance to the exterior of the tri-fold mask 1400 relative to existing tri-fold mask configurations having corresponding exterior seams. The internal seam between the upper panel 1402 and the middle panel 1404 produces a localized four-layer stack that maintains a desired shape of the tri-fold mask 1400 at the junction between the upper panel 1402 and the middle panel 1404 so as to maintain a desired separation between the face of a person wearing the tri-fold mask 1400 and the junction between the upper panel 1402 and the middle panel 1404. The internal seam between the middle panel 1404 and the lower panel 1406 produces a localized four-layer stack that maintains a desired shape of the tri-fold mask 1400 at the junction between the middle panel 1404 and the lower panel 1406 so as to maintain a desired separation between the face of a person wearing the tri-fold mask 1400 and the junction between the middle panel 1404 and the lower panel 1406. Maintaining separation between portions of the tri-fold mask 1400 and the face accommodates airflow between the person's nose and mouth and portions of the panels 1402, 1404, 1406, thereby enabling better airflow through the panels 1402, 1404, 1406 by increasing the area of the panels 1402, 1404, 1406 via which the airflow is filtered.

The tri-fold mask 1400 is configured so that the single strap 1408 applies retention forces to mask 1400 so as to maintain the mask 1400 in sealed engagement with the face. In the illustrated embodiment, the single strap 1408 is attached to the mask 1400 at attachment points located at ends points of the junction between the upper panel 1402 and the middle panel 1404. The attachment points are located so that when the single strap 1408 extends around the head above the ears, the strap 1408 is positioned and oriented to apply retention tensile forces to the mask that are aligned generally with the wearer's chin. The combination of the applied retention forces, the separation between the internal seam between the upper panel 1402 and the middle panel 1404 and the face, and the separation between the internal seam between the middle panel 1404 and the lower panel 1406 and the face serve to produce suitable interface pressure between the perimeter edge portions of the tri-fold mask 1400 and the face, which may support configuration and certification of the mask as an N95 mask.

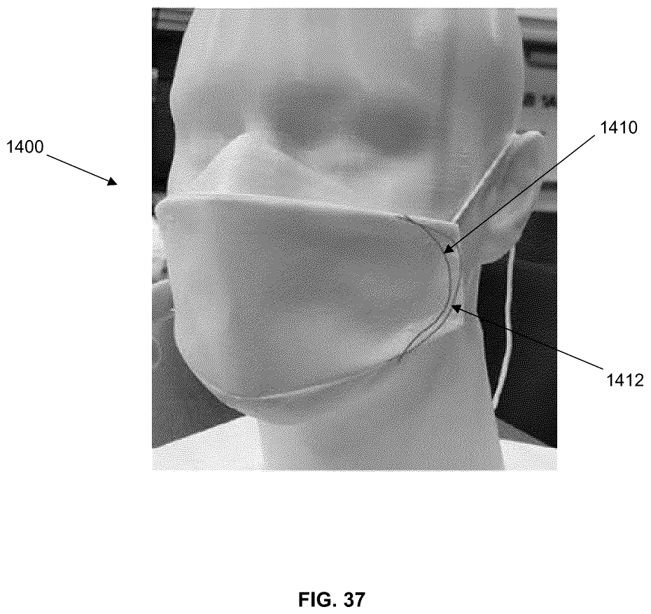

FIG. 37 illustrates some example trim lines 1410, 1412 for the tri-fold mask 1400. The trim lines 1410, 1412 produce a more face-conforming appearance to the tri-fold mask 1400.

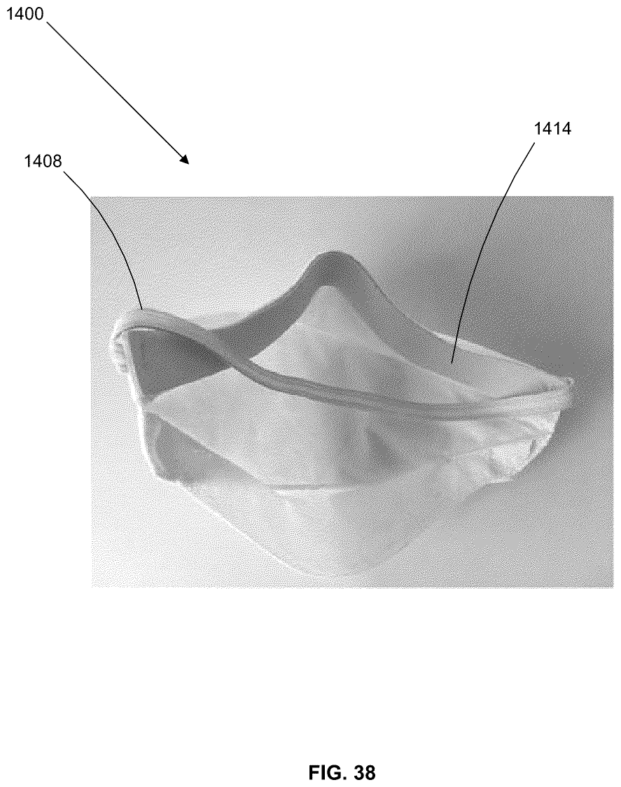

FIG. 38 shows a conformal memory foam upper member 1414 of the tri-fold mask 1400. The conformal memory foam upper member 1414 is shaped to conform to the face to inhibit the occurrence of gaps between the upper perimeter edges of the mask 1400 and the face. In many embodiments, the conformal memory foam upper member 1414 has a suitable amount of flexibility to accommodate usage with different face shapes. In some embodiments, versions of the conformal memory foam upper member 1414 can be sized and shaped for use with respective populations of face shapes.

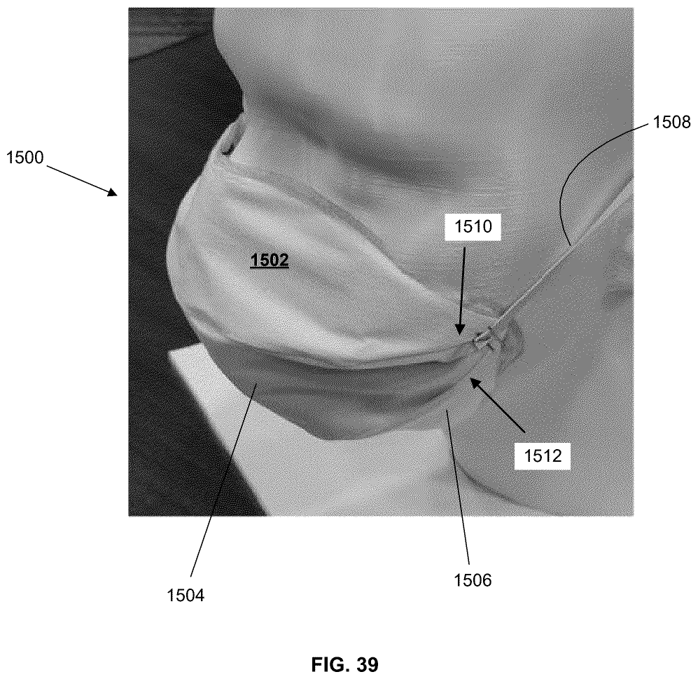

FIG. 39 shows an example tri-fold mask 1500 worn by a mannequin, according to some embodiments. The tri-fold mask 1500 includes an upper panel 1502, a middle panel 1504, a lower panel 1506, and a single strap 1508. The tri-fold mask 1500 is configured similar to the tri-fold mask 1400 so that the single strap 1508 applies retention forces to mask 1500 so as to maintain the mask 1500 in sealed engagement with the face. In the illustrated embodiment, the single strap 1508 is attached to the mask 1500 at attachment points located at ends points of the junction between the upper panel 1502 and the middle panel 1504. The attachment points are located so that when the single strap 1508 extends around the head above the ears, the strap 1508 is positioned and oriented to apply retention tensile forces to the mask that are aligned generally with the wearer's chin. The upper panel 1502 includes a dart 1510 in the left and right end portions of the upper panel 1510 that helps conform the left and right end portions of the upper panel 1510 to the face. The middle panel 1504 includes a dart 1512 in the left and right end portions of the middle panel 1504 that reduces the distance between the attachment points of the single strap 1508 and the ends points of the junction between the middle panel 1504 and the lower panel 1506, thereby providing a more direct path for the retention forces applied by the single strap 1508 to the lower panel 1506.

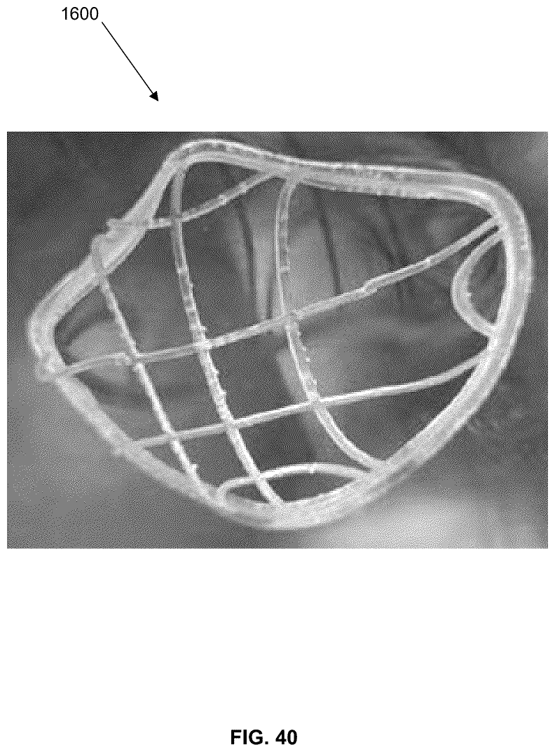

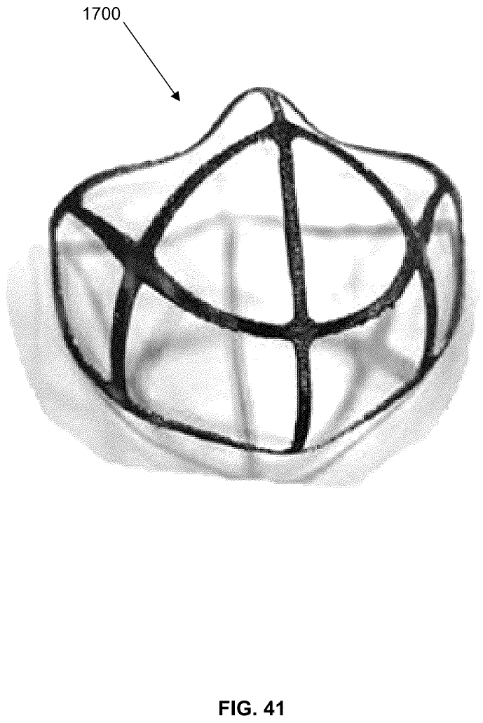

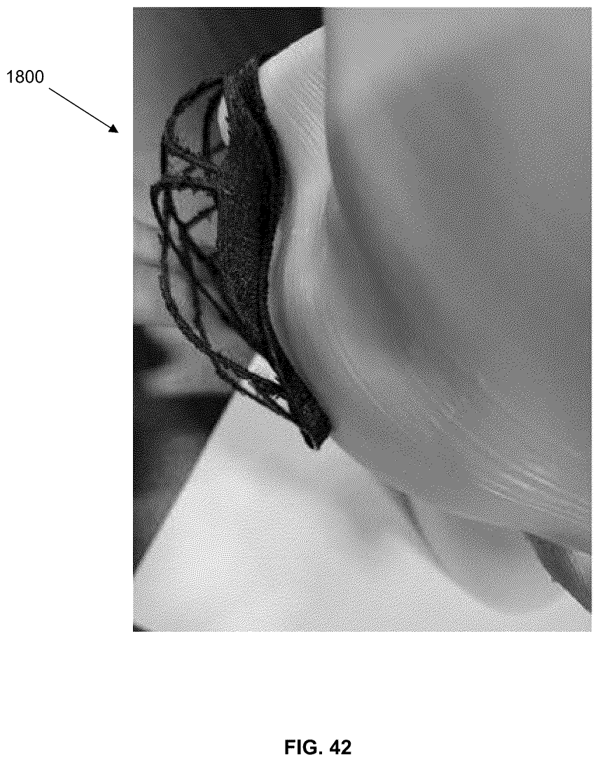

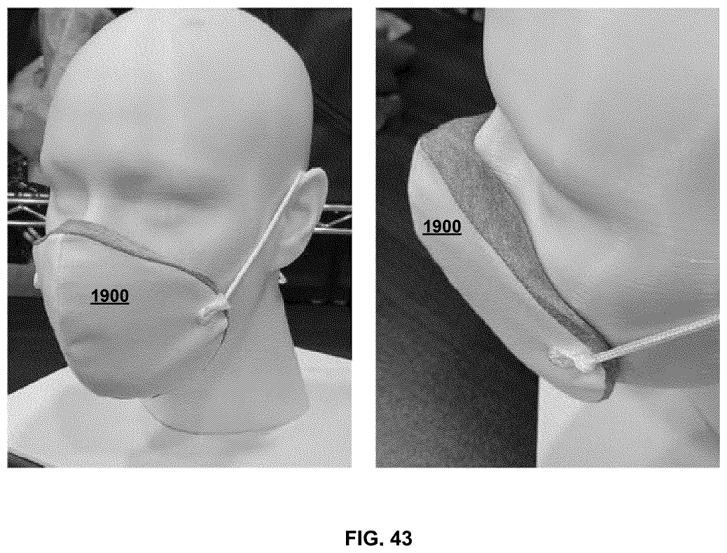

FIG. 40 and FIG. 41 shows example custom printed internal frames 1600, 1700 for face masks. FIG. 42 shows an example custom printed internal frame 1800 for a mask interfaced with a mannequin. In many embodiments, an internal frame 1600, 1700, 1800 includes perimeter edge members shaped to conform to the face and central frame members that maintain separation between one or more filtration panels of a mask and the face to enhance airflow through the filtration panels. FIG. 43 shows views of a mannequin wearing an example bi-fold mask 1900 with an internal frame.

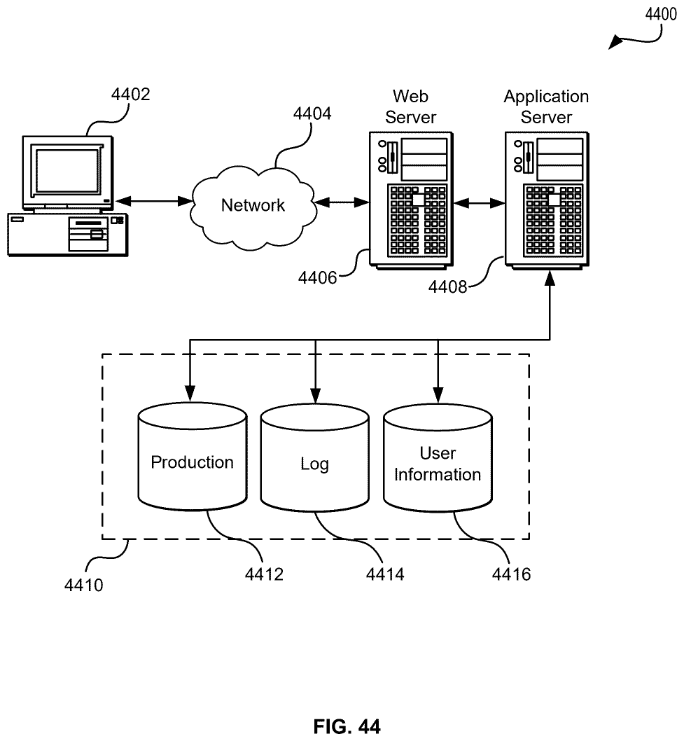

FIG. 44 illustrates aspects of an example environment 4400 for implementing aspects in accordance with various embodiments. As will be appreciated, although a Web-based environment is used for purposes of explanation, different environments may be used, as appropriate, to implement various embodiments. The environment includes an electronic client device 4402, which can include any appropriate device operable to send and receive requests, messages, or information over an appropriate network 4404 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 4406 for receiving requests and serving content in response thereto, although for other networks an alternative device serving a similar purpose could be used as would be apparent to one of ordinary skill in the art.

The illustrative environment includes at least one application server 4408 and a data store 4410. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 4402 and the application server 4408, can be handled by the Web server. It should be understood that the Web and application servers are not required and are merely example components, as structured code discussed herein can be executed on any appropriate device or host machine as discussed elsewhere herein.

The data store 4410 can include several separate data tables, databases or other data storage mechanisms and media for storing data relating to a particular aspect. For example, the data store illustrated includes mechanisms for storing production data 4412 and user information 4416, which can be used to serve content for the production side. The data store also is shown to include a mechanism for storing log data 4414, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 4410. The data store 4410 is operable, through logic associated therewith, to receive instructions from the application server 4408 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 4402. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 44. Thus, the depiction of the system 4400 in FIG. 44 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A face mask comprising:
a filter assembly configured to conform to a face of a user and cover a nose and mouth of the user, wherein the filter assembly comprises a tessellated filter layer shaped to extend above and below a reference medial surface of the tessellated filter layer so that the tessellated filter layer has an air-filtering area greater than an area of the reference medial surface;
a usage limit indicator comprising a usage indicating layer that changes color during usage of the face mask from an initial color to another color that indicates that the face mask has reached a usable life limit; and
a retention mechanism configured to retain the filter assembly to the face of the user.

2. The face mask of claim 1, wherein:
the filter assembly comprises an outer layer and an inner layer; and
the tessellated filter layer is disposed between and enclosed by the outer layer and the inner layer.

3. The face mask of claim 2, wherein:
each of the outer layer and the inner layer consists essentially of a spunbond polypropylene; and
the tessellated filter layer consists essentially of a melt blown polypropylene.

4. The face mask of claim 2, wherein the outer layer comprises a woven fabric configured so that the filter assembly has an appearance of an item of apparel.

5. (canceled)

6. The face mask of claim 1, wherein the filter assembly has a tri-fold configuration.

7. The face mask of claim 1, wherein the tessellated filter layer has one or more of a three-dimensional diamond pattern, a three-dimensional miura pattern, a three-dimensional tria pattern, or an accordion pattern comprising a series of folds.

8. The face mask of claim 1, wherein the usage limit indicator includes a peel tab that can be removed to expose the usage indicating layer.

9. The face mask of claim 1, wherein the retention mechanism comprises one or more retention straps configured to be at least one of adjustable in length, wrapped around ears of the user, or extend around a neck of the user to retain the face mask when not worn on the face of the user.

10. The face mask of claim 9, wherein the retention mechanism comprises a user operable adjustment mechanism having a retention configuration that maintains a length of the one or more retention straps and an adjustment configuration that accommodates user adjustment of the length of the one or more retention straps.

11-20. (canceled)

21. A face mask comprising:
a filter assembly configured to conform to a face of a user and cover a nose and mouth of the user, wherein the filter assembly comprises a tessellated filter layer shaped to extend above and below a reference medial surface of the tessellated filter layer so that the tessellated filter layer has an air-filtering area greater than an area of the reference medial surface;
an internal frame comprising perimeter edge members shaped to conform to a face and central frame members configured to maintain separation between the filter assembly and the face to enhance airflow through the filter assembly, wherein the internal frame comprises a viscoelastic material configured to be impermanently adhered to the tessellated filter layer to facilitate replacement of the internal frame;
a lining that is impermanently adhered to the viscoelastic material to facilitate replacement of the lining, wherein the lining is configured to contact the face of the user to provide a continuous seal that extends around an opening defined by the perimeter edge members; and
a retention mechanism configured to retain the internal frame to the face of the user.

22. The face mask of claim 21, wherein the lining comprises a memory material that enables the lining to reversibly conform to the face of the user.

23. The face mask of claim 22, wherein the memory material comprises ethylene-vinyl acetate foam.

24. The face mask of claim 22, wherein the memory material comprises a polyurethane-based memory-foam.

25. The face mask of claim 21, wherein the lining comprises a material that is moldable above a threshold temperature to accommodate molding of the lining to the face of the user after being heated above the threshold temperature.

26. The face mask of claim 25, wherein the material includes polycaprolactone.

27. The face mask of claim 21, wherein the lining comprises a liquid phase-change material that exhibits a temperature induced phase transition when heated via contact with the face of the user.

28. The face mask of claim 21, wherein the lining comprises a viscoelastic material via which the lining is impermanently adhered to the perimeter edge members.

29. The face mask of claim 21, wherein the filter assembly comprises transparent regions.

30. The face mask of claim 21, further comprising an electrostatic ionizer.

31. The face mask of claim 21, further comprising a heat exchange unit comprising a fan that draws air into the heat exchange unit.

32. The face mask of claim 31, wherein the heat exchange unit further comprises a thermoelectric cooling circuit.

33. The face mask of claim 21, further comprising sensors configured to generate sensor output, wherein the sensors are paired to a mobile device configured to output the sensor output and/or derived values based on the sensor output through a user interface of the mobile device.

34. The face mask of claim 33, wherein the sensors comprise physiological sensors and air quality sensors.
